(19) United States
(12) Patent Application Publication
(10) Pub. No.: US 2026/0082144 A1
(43) Pub. Date: Mar. 19, 2026

(54) Earbuds Charging Case

(71) Applicant: Anker Innovations Technology Co., Ltd., Changsha (CN)

(72) Inventors: Lejiao Huang, Shenzhen (CN); Qi Li, Shenzhen (CN); Dingtao Peng, Shenzhen (CN); Wei Feng, Shenzhen (CN)

(21) Appl. No.: 19/323,853

(22) Filed: Sep. 9, 2025

(30) Foreign Application Priority Data
Sep. 13, 2024 (CN) 202422252395.6

(51) Int. Cl. H04R 1/10

(52) U.S. Cl. CPC H04R 1/1025; H04R 1/1041; H04R 1/1091

(57) ABSTRACT

Disclosed is an earbuds charging case comprising a case body, a case cover and a display. The case body comprises a bottom housing and a middle housing connected to the bottom housing. The middle housing and the bottom housing enclose a mounting cavity. The middle housing comprises an accommodating recess configured to accommodate earbuds, and a first light-transmitting zone. The case cover is movably connected to the case body, and the case cover comprises a second light-transmitting zone. The display is disposed in the mounting cavity or on the middle housing. When the case body is closed by the case cover, a position of the second light-transmitting zone corresponds to the position of the first light-transmitting zone, and content of the display is transmitted through the first light-transmitting zone and the second light-transmitting zone to be displayed on the display.

### CROSS REFERENCE TO RELATED APPLICATION

The present disclosure claims priority of CN Application No. 202422252395.6, filed Sep. 13, 2024, before the China National Intellectual Property Administration, which is incorporated herein by reference in its entirety.

### Field

The present disclosure relates to the technical field of wireless earphones such as earbuds, in particular to an earbuds charging case.

### BACKGROUND

True wireless stereo (TWS) earbuds (e.g., earphones) are characterized by the independence of the left and right earbuds, completely eliminating connecting wires. They can be used directly via Bluetooth connection, and the left and right earbuds can be used separately. With advantages such as portability, comfort, and convenient charging, TWS earbuds have gained increasing popularity.

At present, a charging case of the TWS earbuds in the related art can only charge the TWS earbuds. During the charging process, it is difficult for people to obtain some information on operating status of the earbuds or the charging case directly from the charging case, and there is room in improving the convenience of use.

### SUMMARY

An example of the present disclosure provides an earbuds charging case, which can improve convenience of use of the earbuds charging case.

An example of the present disclosure provides an earbuds charging case comprising a case body, a case cover and a display. The case body comprises a bottom housing and a middle housing connected to the bottom housing. The middle housing and the bottom housing enclose a mounting cavity. The middle housing comprises an accommodating recess configured to accommodate earbuds; and a first light-transmitting zone. The case cover is movably connected to the case body, and the case cover comprises a second light-transmitting zone. The display is disposed in the mounting cavity or on the middle housing. When the case body is closed by the case cover, a position of the second light-transmitting zone corresponds to the position of the first light-transmitting zone, and content of the display is transmitted through the first light-transmitting zone and the second light-transmitting zone to be displayed on the display.

The earbuds charging case according to an example of the present disclosure comprises the case cover and the case body that are movably connected, which is convenient for a user to open and close the earbuds charging case to store and take out the earbuds. The earbuds charging case also comprises the accommodating recess, which is specifically used to stabilize the earbuds to prevent the earbuds in the earbuds charging case from being damaged during carrying.

The earbuds charging case is also provided with the display, which adds an information display function. The display module can be used to display information such as a specific battery level, a charging status, an ambient sound level and a noise reduction level of the earbud, which can improve the user's understanding of earbuds device status data and enrich usage functions of the earbuds charging case.

The design of the first light-transmitting zone and the second light-transmitting zone enables the user to view the information displayed on the display module without opening the case cover, which improves the user's experience, so that the user can quickly obtain the information displayed on the display module without frequently opening and closing the earbuds charging case.

Furthermore, the display is built in the mounting cavity and viewed through the first light-transmitting zone, thereby avoiding direct exposure of the display module to the outside, reducing wear caused by external scratches or friction, effectively protecting the display from external damage, and extending the service life of the display module.

### BRIEF DESCRIPTION OF DRAWINGS

In order to more clearly illustrate technical solutions in examples of the disclosure or in the related art, the drawings that need to be used in description of the examples or the related art are briefly introduced below, and it is apparent that the accompanying drawings described below are merely some examples of the present disclosure, and for those of ordinary skill in the art, other drawings can be obtained based on these drawings without inventive work.

FIG. 1 is a structure diagram of an earbuds charging case according to an example of the present disclosure;

FIG. 2 is a structure diagram of the earbuds charging case when a case cover closes and a display module is off according to an example of the present disclosure;

FIG. 3 is a structure diagram of the earbuds charging case when the case cover closes and the display module is on according to an example of the present disclosure;

FIG. 4 is a structure diagram of the earbuds charging case according to an example of the present disclosure and earbuds;

FIG. 5 is a structure diagram of an earbuds charging case according to another example of the present disclosure;

FIG. 6 is a schematic diagram of an exploded structure of the earbuds charging case in FIG. 3;

FIG. 7 is a schematic diagram of an exploded structure of a case body according to an example of the present disclosure;

FIG. 8 is a schematic diagram of an exploded structure of a middle housing and a display module according to an example of the present disclosure;

FIG. 9 is a schematic diagram of an exploded structure of a middle housing and a display module according to another example of the present disclosure;

FIG. 10 is a structure diagram of a window portion according to an example of the present disclosure;

FIG. 11 is a schematic diagram of an exploded structure of a touch assembly according to an example of the present disclosure;

FIG. 12 is a structure diagram of a sensing electrode according to an example of the present disclosure;

FIG. 13 is a structure diagram of a sensing electrode according to another example of the present disclosure; and

FIG. 14 is a structure diagram of a sensing electrode according to yet another example of the present disclosure.

### DESCRIPTION OF REFERENCE SIGNS

100: earbuds charging case; 10: case body; 10a: mounting cavity; 11: bottom housing; 11a: mounting hole; 111: first light-transmitting zone; 12: middle housing; 12a: accommodating recess; 121: main housing body; 121a: opening; 121b: guide groove; 121c: engagement groove; 122: window portion; 122a: mounting recess; 1221: cover plate; 1222: mounting side plate; 1222a: guide plate; 1222b: fixing plate; 1222c: limiting wall; 20: case cover; 21: second light-transmitting zone; 30: display module; 40: touch assembly; 41: touch panel; 42: sensing electrode; 43: control board; 44: flexible circuit board; 50: battery; 60: bonding member; 200: earbuds.

Achievement of the object, functional features and advantages of the disclosure will be further described in combination with examples and with reference to the accompanying drawings.

### Description of Examples

In order to make the objects, technical solutions, and advantages of the present disclosure more apparent, the present disclosure will be described in detail with reference to the accompanying drawings.

In the following description regarding the drawings, the same signs in different drawings represent the same or similar elements, unless otherwise indicated. The examples described below are merely examples and do not represent all examples consistent with the present disclosure. Rather, the examples are merely examples of devices and methods that are consistent with some aspects of the present disclosure as detailed in the appended claims.

In the description of the present disclosure, it is understood that the terms “first”, “second”, and the like are used for descriptive purposes only and should not be construed as indicating or implying relative importance. For those of ordinary skill in the art, the specific meaning of the above terms in the present disclosure can be understood according to specific circumstances. In the description of the present disclosure, unless otherwise specified, “multiple” means two or more. In addition, “and/or” describes a relationship between associated objects, indicating that there may be three relationships. For example, A and/or B may indicate three cases: A alone, A and B at the same time, and B alone. The symbol “/” generally indicates that the relationship between the associated objects is “or”.

Unless otherwise defined, all technical and scientific terms used herein have the same meanings as generally understood by those skilled in the art of the present disclosure. The terms used in this description are for the purpose of describing specific examples only and are not intended to limit the present disclosure. As used herein, the term “and/or” includes any and all combinations of one or more related listed items.

Wireless earbuds, by eliminating the cable, solve issues common with wired earphones (e.g., earbuds) such as tangled cords and inconvenient use. However, wireless earbuds require recharging after extended use. Taking TWS (True Wireless Stereo) earbuds as an example, they are typically equipped with a corresponding charging case for recharging. In the related art, a TWS earbuds charging case charges the earbuds through an internal battery and is provided with magnetic members to fix the earbuds in a specific position to ensure stability and accuracy during charging. Some earbuds charging cases are equipped with an LED indicator light to display a charging status and battery level information. For example, a TWS earbuds charging case may have three LED lights, which indicate a state such as a sufficient battery level, charging, or a low battery level with different blinking patterns or colors.

However, while the LED indicator lights provide basic charging status information, the LED indicator lights have limited display capabilities and typically can only provide simple battery level or status indication. This display method has some limitations, which makes it difficult for users to accurately know the remaining battery level of the earbuds or the charging case. Thus, functions of the existing earbuds charging case are relatively simple and cannot fully meet needs of users.

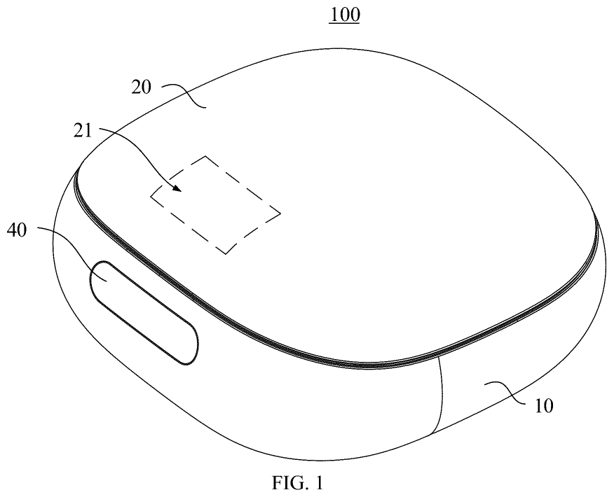

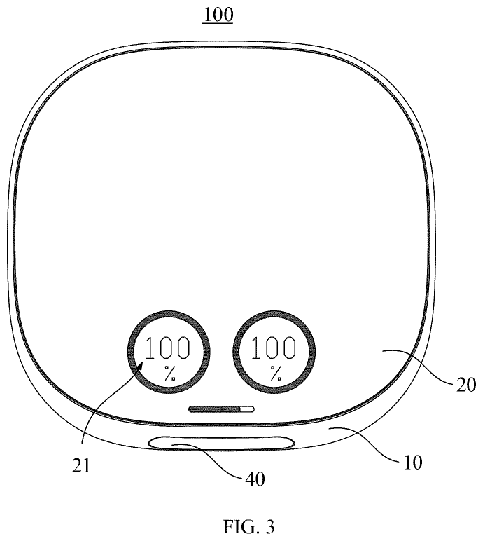

To address the above issues, referring to FIGS. 1 to 5, the present disclosure describes an earbuds charging case 100. In an example of the present disclosure, the earbuds charging case 100 may be circular or cubical in shape and includes a case body 10 and a case cover 20. The case body 10 comprises an accommodating recess 12a configured to accommodate earbuds 200. The case body 10 is configured to accommodate and protect the earbuds 200, and may be made of plastic, which has certain strength and durability. The case cover 20 may be movably connected to the case body 10 and is configured to close and open the case body 10 e.g., the earbuds charging case 100 has an open state and a closed state), so that the earbuds 200 are protected from dust and external scratches when accommodated in the accommodating recess 12a. The case cover 20 may be made of a material similar to that of the case body 10.

In one configuration, the case cover 20 may be slidably connected to the case body 10, and a user can slide the case cover 20 to open or close with one hand. The sliding connection can reduce noise that may be generated due to frequent operations. In another configuration, the case cover 20 can be flippably connected to the case body 10. For example, the case cover 20 may be pivotably connected to the case body 10. The flip cover structure usually automatically opens and closes via a spring or other mechanical devices. The user only needs to gently press an opening button or operate the case cover 20 to complete an opening operation, which is very simple.

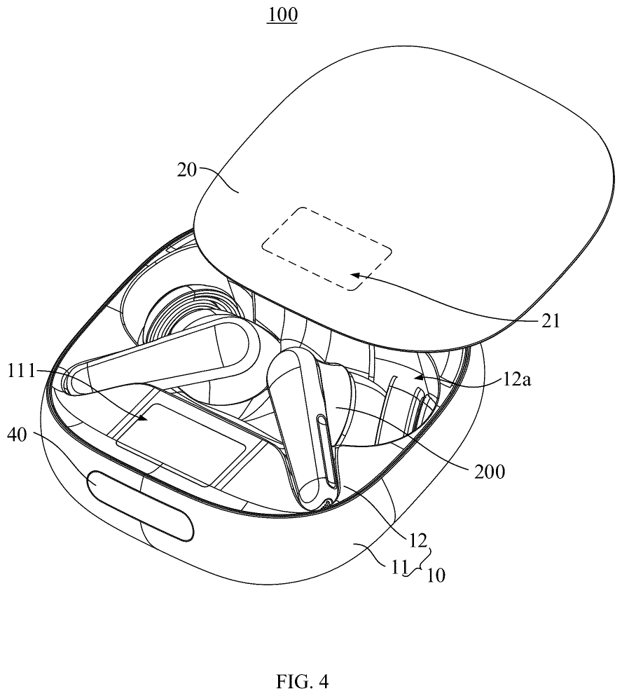

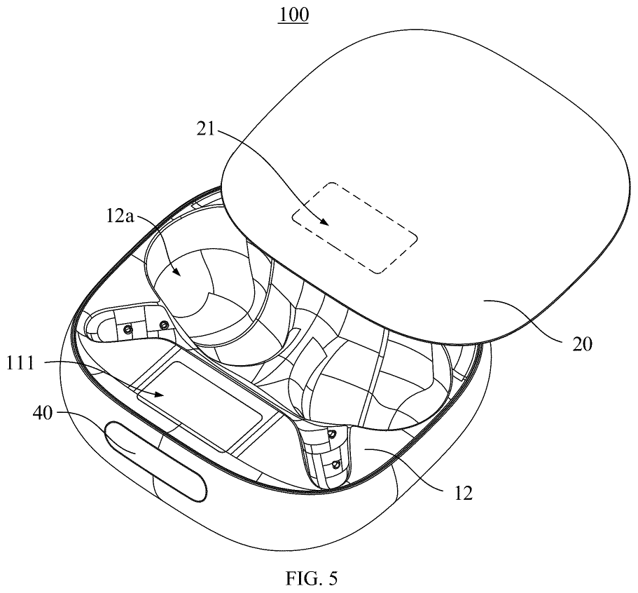

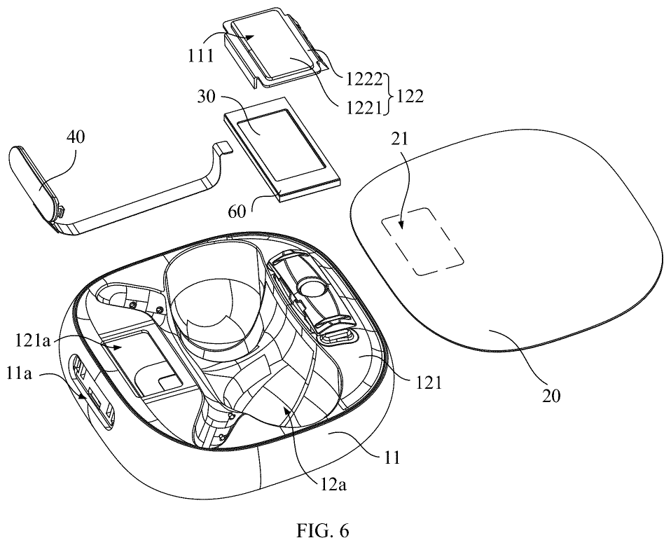

As illustrated in FIGS. 4 and 6, the earbuds charging case 100 may further include a display module 30. The display module 30 can provide an information display function, which can be used to display information such as a specific battery level, a charging status, an ambient sound level, and/or a noise reduction level of the earbuds 200, thereby improving the user's understanding of the device status of the earbuds 200 and enhancing the convenience of the earbuds charging case 100.

Further, the display module 30 may include a display screen and a driving circuit electrically connected to the display screen. The display screen is a core part of the display module, and the driving circuit is configured to control pixels on the display screen to generate images or texts. The driving circuit may be configured to adjust a voltage and current as needed to drive (e.g., generate, determine) the pixels on the display screen.

There may be two accommodating recesses 12a (e.g., accommodating chambers) which may be arranged opposite to each other, and the display module 30 may be located between the two accommodating recesses 12a. The display module 30 located at a center position may improve visibility and readability of information displayed on the display module 30.

Furthermore, the accommodating recess 12a may include a top recess and a bottom recess in communication with each other. The top recess is configured to place a head (e.g., a top portion) of the earbud, and the bottom recess is configured to accommodate a stem of the earbud. The display module 30 may be located between the two bottom recesses.

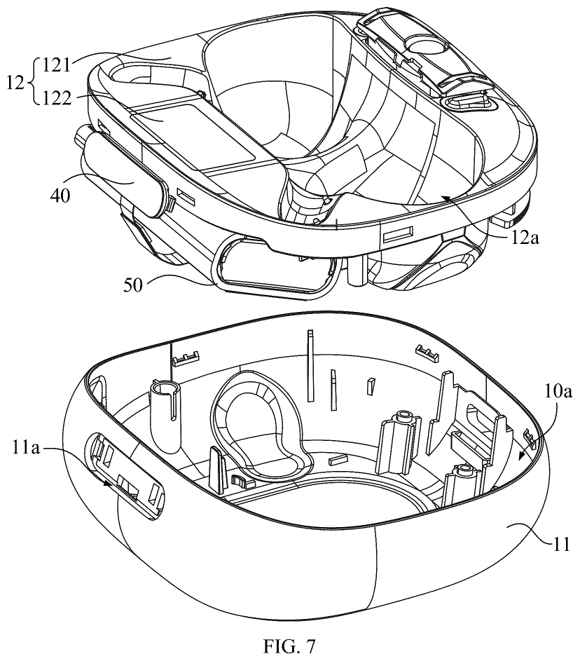

As illustrated in FIG. 4 and FIG. 7, the case body 10 may include a bottom housing 11 and a middle housing 12 connected to the bottom housing 11. The bottom housing 11 provides bottom support for the case body 10 and provides stability of structure of the case body 10. The accommodating recess 12a may be provided in the middle housing 12, and the middle housing 12 can provide support for the earbuds 200 to ensure that the earbuds 200 are stably placed in the earbuds charging case 100. The middle housing 12 and the bottom housing 11 enclose a mounting cavity 10a, which can be configured to accommodate a battery 50 and/or other electronic components.

In one configuration, the display module 30 may be disposed in the mounting cavity 10a, which can avoid the display module 30 from being directly exposed to the outside, prevent direct damage to the display module 30 due to accidental scratches or fall, reduce influence of dust, moisture and other pollutants that may affect performance of the display module 30 on the display module 30, effectively protect the display module 30 from external damage, and extend the service life of the display module 30.

In another configuration, the display module 30 may be disposed on the middle housing 12. A recess may be provided in the middle housing 12, and the display module 30 may be accommodated in the recess, which helps to fix a position of the display module 30 and reduce vibration or displacement during transportation or use.

Referring to FIGS. 4 and 6, the middle housing 12 may be further provided with a first light-transmitting zone 111, and the case cover 20 may be provided with a second light-transmitting zone 21. A position of the second light-transmitting zone 21 corresponds to a position of the first light-transmitting zone 111. When the case body 10 is closed by the case cover 20, display content of the display module 30 can transmit through the first light-transmitting zone 111 and the second light-transmitting zone 21, so that the user can see the content displayed on the display module 30 from the outside of the earbuds charging case 100. When the case body is opened by the case cover (e.g. the case cover does not cover the entirety of the case body), a part of the middle housing 12 with the first light-transmitting zone 111 is exposed to the outside, so that the display content of the display module 30 can directly transmit through the first light-transmitting zone 111 and the user can directly obtain the content displayed on the display module 30. Therefore, regardless of whether the case cover 20 closes or opens, the user can view the display information displayed on the display module 30 without frequently opening and closing the earbuds charging case 100, which improves the user's experience.

It should be noted that the middle housing 12 may be a transparent middle housing made of plastic or resin. For example, the whole middle housing 12 is the first light-transmitting zone 111. The case cover 20 may be a transparent case cover made of plastic or resin. For example, the whole case cover 20 is the second light-transmitting zone 21. Alternatively, part of the middle housing 12 may be a transparent middle housing portion, and part of the case cover 20 may be a transparent case cover portion. When the case body 10 is closed by the case cover 20, at least part of the transparent middle housing portion can be disposed facing the transparent case cover portion in an up-down direction, and the display module 30 is disposed facing the transparent middle housing portion, so that the user can see the content displayed on the display module 30 through the case cover 20 and the middle housing 12 when the case cover 20 closes.

The case cover 20 may be an integrally formed structural part, and/or the middle housing 12 may be an integrally formed structural part. With the integrally formed structural part, the number of components to be assembled during assembly can be reduced. For example, a non-light-transmitting zone may be formed by directly applying paint to the transparent case cover 20, and part of the light-transmitting zone may be retained to form the second light-transmitting zone 21. Accordingly, it is possible to reduce the number of connection points and maintain integrity of the case cover 20, achieving seamless connection in appearance and maintaining smoothness of lines in appearance.

In some examples of the present disclosure, an upper surface of the case cover 20 is a smooth curved surface. The smooth surface can reduce scratches against other objects and provide a better grip feeling for the user. It is also easier to wipe and clean the case cover 20, which helps to maintain the earbuds charging case 100 clean.

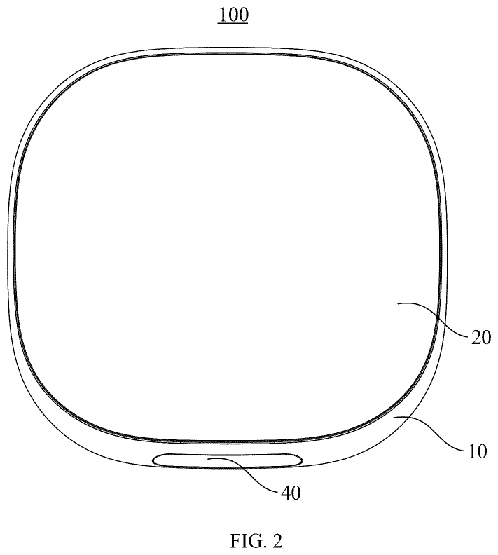

As illustrated in FIGS. 2, 3 and 6, in some examples of the present disclosure, the second light-transmitting zone 21 is configured to allow unidirectional transmission of light from the inside to the outside. When the case cover 20 closes, the special design of the second light-transmitting zone 21 can allow unidirectional transmission of light from the inside to the outside. When the display module 30 is on, a user can see the display content on the display module 30. When the display module 30 is off, the user can only see the surface of the case cover 20 from the outside and cannot see the display module 30 that is off, which provides a clearer and undisturbed visual experience. The unidirectional transmission function of the second light-transmitting zone 21 effectively prevents external light from interfering with the display module 30.

Referring to FIGS. 2 and 6 again, in some examples of the present disclosure, when the case body 10 is closed by the case cover 20 and the display module 30 is off, the second light-transmitting zone 21 is configured to present an integrated effect with the other parts of the case cover 20. With the integrated effect, the second light-transmitting zone 21 does not appear unnatural when there is no need to display content, and is integrated with the other parts of the case cover 20. The user may not be affected by the second light-transmitting zone 21 when the display module 30 is off, and the overall appearance design of the earbuds charging case 100 may not be impaired, thereby enhancing the overall beauty of the earbuds charging case 100.

The display in an integrated effect can also prevent others from peeping into the charging case through the second light-transmitting zone 21, thereby protecting the user's privacy. When the case cover 20 closes and the display module 30 is on, the second light-transmitting zone 21 is configured to show the content of the display module 30. For example, when the content of the display module 30 needs to be viewed, the second light-transmitting zone 21 can clearly show information without affecting the user's operation and viewing.

For example, a side of the second light-transmitting zone 21 facing the display module 30 has low reflectivity, allowing more light to transmit therethrough, so that when the display module 30 performs display, light emitted by the display module 30 can transmit through the second light-transmitting zone 21 and be seen by the user from the outside. A side of the second light-transmitting zone 21 away from the display module 30 may have high reflectivity and can reflect light from an external environment, so that the user sees his/her own reflected image or reflection of a surrounding environment rather than the internal structure of the display module 30. Accordingly, the second light-transmitting zone 21 and the other parts of the case cover 20 are integrated, thereby achieving an integrated effect.

In some examples of the present disclosure, a light shielding film is provided on the surface of the case cover 20 and at least covers the second light-transmitting zone 21. The light shielding film is usually made of a special material with unidirectional light transmittance. This material is designed with fine holes or structures that allow light to pass in one direction and block light in the opposite direction. The display module 30 emits light actively, which has certain brightness and directionality. With the design of the light shielding film, light is allowed to transmit therethrough and propagate in a predetermined direction. However, external light is usually in random directions, with the design of the light shielding film, light penetration is reduced by absorption, scattering or internal reflection when the light shielding film receives the external light.

In some examples of the present disclosure, the light shielding film may cover an entire surface of the case cover 20. When the display module 30 is off, the light shielding film makes the second light-transmitting zone 21 have no difference in appearance from the other parts of the case cover 20, achieving a visual integration effect. The entire surface of the case cover 20 is covered with the light shielding film to ensure consistency of the appearance of the earbuds charging case 100, without any difference in color or texture, making the product look more exquisite. The surface of the case cover 20 covered with the light shielding film is easier to clean since stains are not easy to adhere to the light shielding film.

Referring to FIG. 7, in some examples of the present disclosure, the middle housing 12 may include a main housing body 121 and a window portion 122. The main housing body 121 and the window portion 122 can be provided separately, which achieves a more modular design of the middle housing 12, facilitating production and maintenance. The main housing body 121 constitutes a base component of the middle housing 12, and may be provided with the accommodating recess 12a. The window portion 122 may be disposed facing the display module 30 in the up-down direction, allowing the user to see the display information displayed on the display module 30. The window portion 122 may be a transparent window made of polymethyl methacrylate (PMMA, acrylic), which has good transparency and strength. Alternatively, the window portion 122 may be a glass window portion 122, which provides higher transparency and wear resistance. The main housing body 121 may be a non-light-transmitting main housing body 121 which can shield the battery 50 and other electronic components disposed inside the mounting cavity, avoid the internal structure from being directly exposed to the sight, and keep a neat and uniform appearance of the earbuds charging case 100 when the case body 10 is opened by the case cover 20.

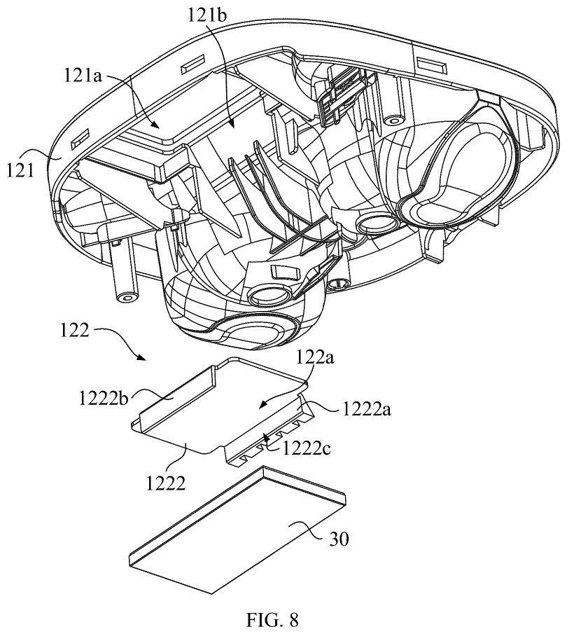

As illustrated in FIGS. 7 and 8, the main housing body 121 may be provided with an opening 121a, and the window portion 122 may be connected to the main housing body 121 and covers the opening 121a. The window portion 122 forms the first light-transmitting zone 111. A size and position of the opening 121a and the first light-transmitting zone 111 can be adjusted as needed. Through the first light-transmitting zone 111, the user can intuitively see the information displayed on the display module 30 in the mounting cavity.

A surface of the window portion 122 is flush with a surface of the main housing body 121. The flush design makes a joint between the window portion 122 and the main housing body 121 less obvious, providing a smooth and continuous surface for the middle housing 12, enhancing aesthetics of the earbuds charging case 100, and reducing scratches and wear that may be caused by unevenness on the middle housing 12.

Referring to FIGS. 7 and 8 again, the display module 30 may be connected to the window portion 122. During mounting, the display module 30 is first connected to the window portion 122, and then the window portion 122 is provided at the opening 121a and connected to the main housing body 121. Accordingly, it is possible to ensure that the display module 30 is accurately aligned with the first light-transmitting zone 111, avoiding the problem of misalignment or inaccurate alignment that may occur during assembly. Furthermore, this assembly method can simplify the entire assembly process since the position and alignment of the display module 30 are determined when the display module 30 is connected to the window portion 122, thereby reducing an adjustment procedure required in a case of assembling the display module 30 and the window portion 122 separately.

When the case cover 20 is configured to be slidably connected to the case body 10, a sliding direction thereof can be set along a direction from the window portion 122 to the accommodating recess 12a. The sliding direction is coincident with the direction from the window portion 122 to the accommodating recess 12a, maintaining the coherence and consistency of the design.

As illustrated in FIGS. 8 to 10, in some examples of the present disclosure, the window portion 122 may include a cover plate 1221 and a mounting side plate 1222 connected to a periphery of the cover plate 1221. The cover plate 1221 covers the opening 121a and forms the first light-transmitting zone 111. The cover plate 1221 allows light to transmit therethrough from an area of the display module 30 while protecting the display module 30 from external damage. The mounting side plate 1222 can provide additional support for the cover plate 1221 to ensure stability of the cover plate 1221 when being mounted in the opening 121a. The cover plate 1221 and the mounting side plate 1222 enclose a mounting recess 122a. The display module 30 may be disposed in the mounting recess 122a, which can protect the display module 30 from being easily displaced due to external impact.

In some examples of the present disclosure, the earbuds charging case 100 may further include a bonding member 60 (as illustrated in FIG. 6). The bonding member 60 may be glue, double-sided adhesive tape, or other similar materials. The display module 30 may be bonded and fixed to a recess wall of the mounting recess 122a through the bonding member 60, so that the display module 30 is firmly fixed to the window portion 122, thereby reducing displacement or falling off caused by vibration or impact. In other configurations, the display module 30 and the window portion 122 may be connected by screwing or locking, which is not limited in the present disclosure.

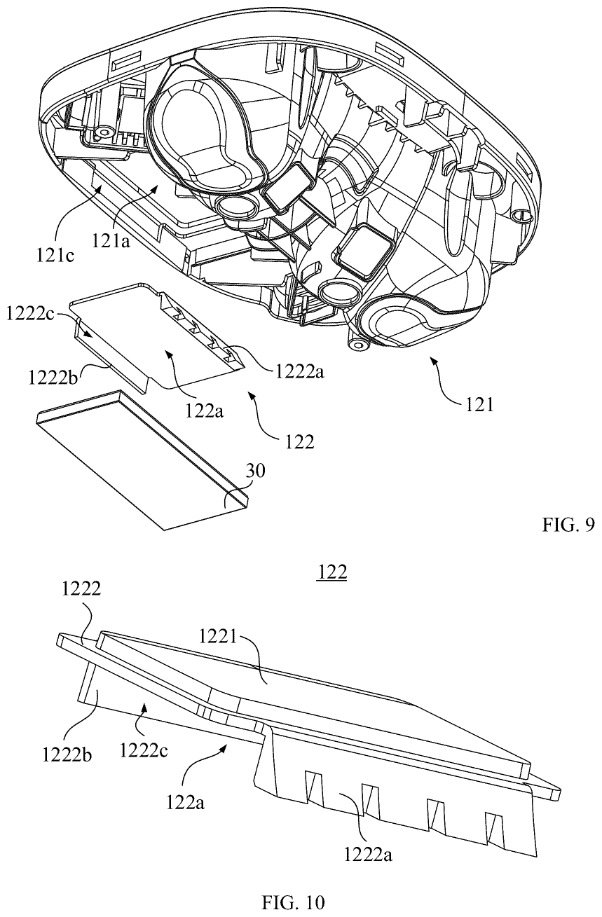

As illustrated in FIGS. 8 and 9, in some examples of the present disclosure, the mounting side plate 1222 may include a guide plate 1222a and a fixing plate 1222b, and the main housing body 121 may be provided with a guide groove 121b fitting the guide plate 1222a. The guide plate 1222a is slidably connected to the guide groove 121b. For example, when the window portion 122 is assembled, the window portion 122 is inserted from a side of the main housing body 121 where the guide groove 121b is provided, and the guide groove 121b can guide the guide plate 1222a to slide smoothly toward the opening 121a according to a preset trajectory, without complicated alignment or adjustment steps, thereby speeding up the assembly of the window portion 122 to the main housing body 121.

Further, the main housing body 121 may be provided with an engagement groove 121c fitting the fixing plate 1222b, and the fixing plate 1222b is engaged with the engagement groove 121c. When the mounting side plate 1222 slides to a suitable position, the fixing plate 1222b can be embedded in the engagement groove 121c, achieving engagement fitting of the fixing plate 1222b to the engagement groove 121c, so that the window portion 122 and the main housing body 121 are firmly assembled.

Further, the guide plate 1222a may have a guide surface that provides a smooth guide path along an inclined direction toward the opening 121a, so that the mounting side plate 1222 can more easily slide into and be positioned at the opening 121a of the main housing body 121. The inclined guide surface reduces scratches between the mounting side plate 1222 and the main housing body 121, and a thickness of the guide plate 1222a gradually increases in a direction away from the opening 121a, which helps to achieve progressive fitting with the guide groove 121b, thereby providing better adaptability and tightness during assembly.

Referring to FIGS. 8 and 9 again, in some examples of the present disclosure, two facing sidewalls of the guide plate 1222a and the fixing plate 1222b may be each provided with a limiting wall 1222c, and the cover plate 1221 and the two limiting walls 1222c may jointly enclose the mounting recess 122a. The limiting wall 1222c can limit the display module 30 to prevent the display module 30 from tilting or shifting. The limiting wall 1222c can provide additional protection for the display module 30 and reduce potential damage to the display module 30 during use.

By fixing the display module 30 to the window portion 122, the display module 30 may be first fixed to the window portion 122 outside the case body 10 during the assembly process of the earbuds charging case 100. In this process, since the operation is not performed in a narrow space inside the case body 10, the assembly efficiency is higher. Moreover, in the scheme of the present disclosure, the display module 30 and the window portion 122 constitute an integral module, the integral module is then fixed to the case body 10 by engagement, which will further improve the assembly efficiency.

As illustrated in FIGS. 6 and 7, in order to further improve the convenience in using the earbuds charging case 100, in some examples of the present disclosure, a mounting hole 11a is provided on the bottom housing 11 and is in communication with the mounting cavity 10a. The earbuds charging case 100 may further include a touch assembly 40 configured to implement a touch operation. The touch assembly 40 may be accommodated in the mounting cavity 10a and may be partially exposed in the mounting hole 11a. The touch assembly 40 is electrically connected to the display module 30, so that the earbuds charging case 100 can realize personalized settings according to the user's preference through intelligent interaction.

The bottom housing 11 may include a bottom wall and sidewalls. The bottom wall may be disposed facing the middle housing 12, and the sidewalls extend from an outer edge of the bottom wall to an outer edge of the middle housing 12. The mounting hole 11a may be provided in the sidewall (e.g., a peripheral sidewall part of the bottom housing 11), which is easier for a user to directly operate, improving the convenience of use.

In some examples of the present disclosure, a charging interface may be further provided on a side of the sidewall facing the mounting hole 11a, which is conducive to reasonable allocation of an internal space of the earbuds charging case 100 and avoids interference between the electronic components.

In the present example, a touch function is added to the earbuds charging case 100. Accordingly, quick and convenient control on the earbuds charging case 100 and the wireless earbuds 200 can be realized according to the user's operation on the touch assembly 40, thereby improving the user's experience. Further, the earbuds charging case 100 is not limited to an auxiliary device that provides auxiliary functions for the earbuds 200, and can realize personalized settings such as an ambient sound level, a noise reduction level, air pressure calibration, image capturing, finding earbuds 200, and spatial audio function adjustment.

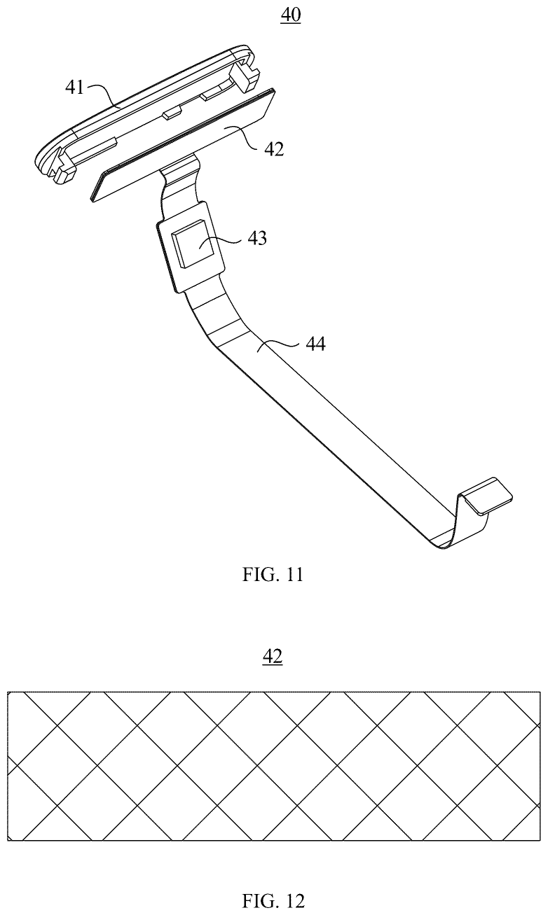

As illustrated in FIG. 11, in some examples of the present disclosure, the touch assembly 40 may include a touch panel 41, two or more sensing electrodes 42, and a control board 43. The touch panel 41 is disposed in the mounting hole 11a and can be exposed in the mounting hole 11a to provide a touch operation area for the user. The user can execute various control commands through the touch panel 41. The two or more sensing electrodes 42 are provided to support multi-touch, allowing the user to perform a more complex gesture operation. The two or more sensing electrodes 42 are accommodated in the mounting cavity 10a and are disposed facing the touch panel 41. The sensing electrodes 42 are configured to sense control signals transmitted when the user operates the touch panel 41. When the user performs a touch operation on the touch panel 41, such as a touch slide, a long press, or a double click, the sensing electrodes 42 can detect changes on the touch panel 41 and generate corresponding electrical signals. The control board 43 is accommodated in the mounting cavity 10a and is electrically connected to the two or more sensing electrodes 42. The control board 43 is configured to receive control signals sensed by the sensing electrodes 42 and convert these control signals into specific control commands. The control board 43 can quickly respond to the user's touch operation and provide the user with instant operation feedback.

By providing the touch panel 41 in place of a traditional physical button, mechanical wear can be reduced, and the service life of the earbuds charging case 100 can be extended.

As illustrated in FIGS. 6 and 11, in some examples of the present disclosure, the touch panel 41 may be disposed on a side of the window portion 122 away from the accommodating recess 12a, and may be disposed adjacent to the window portion 122. The touch panel 41 and the display module 30 may be disposed at adjacent positions to form a centralized control and information display area, thereby improving interaction efficiency of the user. The touch panel 41 may not be disposed adjacent to an area where the earbuds 200 are placed, thereby reducing a possibility of accidentally touching the control panel when taking and placing the earbuds 200.

For example, the two or more sensing electrodes 42 can be bonded to the touch panel 41 on a side facing the mounting cavity 10a. The bonding can ensure a stable connection between the sensing electrodes 42 and the touch panel 41, preventing displacement or falling off caused by vibration or impact. Furthermore, as a fixing method, the bonding can simplify the assembly process of the sensing electrodes 42 and the touch panel 41.

In some configurations, the control board 43 comprises a microcontroller unit (MCU) whose core is equipped with a digital signal processing (DSP) circuit, which can quickly process complex algorithms, meet processing requirements of real-time signals, and provide a faster response. Through software algorithms, complex touch operations such as left and right slides, a single click, a double click, and a long press can be implemented.

In some configurations, the sensing electrode 42 is a capacitive sensing electrode 42. The capacitive sensing electrode 42 supports the multi-touch technology and allows the user to operate with multiple fingers at the same time, achieving a richer interaction experience. Moreover, the capacitive sensing electrode 42 has lower power consumption, which helps to extend the service life of the earbuds charging case 100.

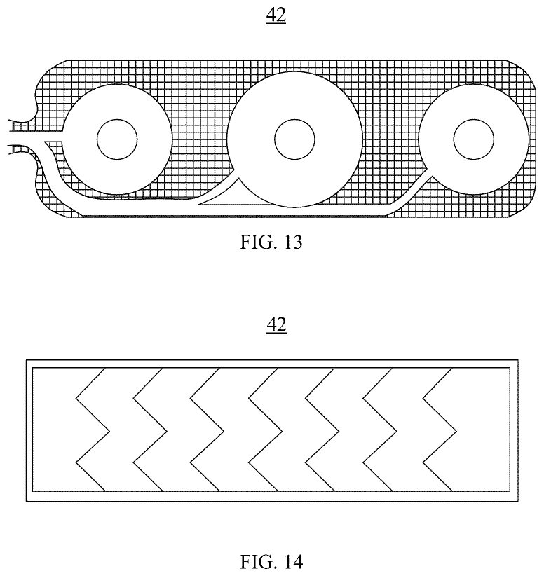

As illustrated in FIG. 12 to FIG. 14, in some configurations, the sensing electrode 42 is rhombus-shaped, circular, or W-shaped. The sensing electrodes 42 in a specific shape can define an effective touch area on the touch panel 41 to ensure that the user operates within an intended area. The sensing electrodes 42 of different shapes can improve the recognition of touch signals and reduce an accidental touch and missed touch.

As illustrated in FIG. 11, in some examples of the present disclosure, the touch assembly 40 may further include a flexible circuit board 44 with a property of being bendable. The flexible circuit board 44 may be disposed in the mounting cavity 10a, enabling complex wiring in the compact mounting cavity 10a and improving space utilization of the mounting cavity 10a. The two or more sensing electrodes 42 may be electrically connected to the control board 43 via a flexible circuit. The flexible circuit board 44 is prone to be integrated with various electronic components to facilitate multi-touch control.

The same or similar reference signs in the drawings of the example correspond to the same or similar components. In the description of the present disclosure, it should be understood that if the terms “up”, “down”, “left”, “right”, and the like indicate directions or positional relationships based on the directions or positional relationships shown in the drawings, it is only for the convenience of describing the disclosure and simplifying the description, and does not indicate or imply that the device or element referred to must have a specific direction, be constructed and operated in a specific direction. Therefore, the terms describing the positional relationship in the drawings are only used for illustrative purposes and cannot be understood as limitations on the present disclosure. For those of ordinary skill in the art, the specific meanings of the above terms can be understood according to specific circumstances.

The above are only preferred examples of the present disclosure and are not intended to limit the present disclosure. Any modifications, equivalent substitutions and improvements made within the spirit and principles of the present disclosure should be included in the protection scope of the present disclosure.

What is claimed is:

1. An earbuds charging case comprising:
a case body comprising:
a bottom housing;
a middle housing connected to the bottom housing, wherein the middle housing and the bottom housing enclose a mounting cavity, and the middle housing comprises an accommodating recess configured to accommodate earbuds; and
a first light-transmitting zone;
a case cover movably connected to the case body, the case cover comprising a second light-transmitting zone; and
a display disposed in the mounting cavity or on the middle housing, wherein when the case body is closed by the case cover, a position of the second light-transmitting zone corresponds to the position of the first light-transmitting zone, and content is transmitted through the first light-transmitting zone and the second light-transmitting zone to be displayed on the display.

2. The earbuds charging case of claim 1, wherein the second light-transmitting zone is configured to allow unidirectional transmission of light from inside of the earbuds charging case to outside of the earbuds charging case.

3. The earbuds charging case of claim 1, wherein when the case body is closed by the case cover and the display is turned off, the second light-transmitting zone is configured to present an integrated effect with other parts of the case cover.

4. The earbuds charging case of claim 1, wherein:
the case cover comprises a light shielding film on a surface of the case cover, and
the light shielding film covers at least the second light-transmitting zone.

5. The earbuds charging case of claim 4, wherein the light shielding film covers an entire surface of the case cover.

6. The earbuds charging case of claim 1, wherein:
the middle housing comprises a main housing body and a window portion,
the main housing body comprises an opening, and the window portion is connected to the main housing body and covers the opening, and
the window portion forms the first light-transmitting zone, in which a surface of the window portion is flush with a surface of the main housing body.

7. The earbuds charging case of claim 6, wherein the display is connected to the window portion.

8. The earbuds charging case of claim 6, wherein:
the window portion includes a cover plate and a mounting side plate connected to a periphery of the cover plate,
the cover plate covers the opening and forms the first light-transmitting zone,
the cover plate and the mounting side plate enclose a mounting recess, and
the display is disposed in the mounting recess.

9. The earbuds charging case of claim 8, wherein:
the mounting side plate comprises a guide plate and a fixing plate disposed opposite to the guide plate,
the main housing body comprises a guide groove and an engagement groove,
the guide plate is slidably connected to the guide groove, and
the fixing plate is engaged with the engagement groove.

10. The earbuds charging case of claim 8, further comprising a bonding member, wherein the display is bonded and fixed to a recess wall of the mounting recess through the bonding member.

11. The earbuds charging case of claim 1, wherein:
a mounting hole is provided on the bottom housing and is in communication with the mounting cavity; and
the earbuds charging case further comprises a touch assembly accommodated in the mounting cavity and partially exposed in the mounting hole, and the touch assembly is electrically connected to the display.

12. The earbuds charging case of claim 11, wherein the touch assembly comprises:
a touch panel disposed in the mounting hole;
two or more sensing electrodes accommodated in the mounting cavity and disposed facing the touch panel, wherein the two or more sensing electrodes are configured to sense control signals transmitted by the touch panel; and
a control board accommodated in the mounting cavity and electrically connected to the two or more sensing electrodes, wherein the control board is configured to receive control signals sensed by the sensing electrodes.

13. The earbuds charging case of claim 1, wherein the case cover is slidably connected to the case body.

14. An earbuds charging case comprising:
a case body comprising:
a bottom housing;
a middle housing connected to the bottom housing, wherein the middle housing and the bottom housing enclose a mounting cavity, and the middle housing comprises an accommodating recess configured to accommodate earbuds; and
a first light-transmitting zone;
a case cover movably connected to the case body, the case cover comprising a second light-transmitting zone; and
a display disposed on the middle housing, wherein when the case body is opened by the case cover, content is transmitted through the first light-transmitting zone to be displayed on the display.

15. The earbuds charging case of claim 14, wherein when the case body is opened by the case cover, at least a part of the middle housing 12 is exposed to outside of the earbuds charging case.

16. The earbuds charging case of claim 14, wherein:
the case cover comprises a light shielding film on a surface of the case cover, and the light shielding film covers at least the second light-transmitting zone.

17. The earbuds charging case of claim 14, wherein:
the middle housing comprises a main housing body and a window portion,
the main housing body comprises an opening, and the window portion is connected to the main housing body and covers the opening, and
the window portion forms the first light-transmitting zone, in which a surface of the window portion is flush with a surface of the main housing body.

18. The earbuds charging case of claim 14, wherein:
a mounting hole is provided on the bottom housing and is in communication with the mounting cavity; and
the earbuds charging case further comprises a touch assembly accommodated in the mounting cavity and partially exposed in the mounting hole, and the touch assembly is electrically connected to the display.

19. The earbuds charging case of claim 18, wherein the touch assembly comprises:
a touch panel disposed in the mounting hole;
two or more sensing electrodes accommodated in the mounting cavity and disposed facing the touch panel, wherein the two or more sensing electrodes are configured to sense control signals transmitted by the touch panel; and
a control board accommodated in the mounting cavity and electrically connected to the two or more sensing electrodes, wherein the control board is configured to receive control signals sensed by the sensing electrodes.

20. The earbuds charging case of claim 14, wherein the case cover is slidably connected to the case body.
